(19) United States
(12) Patent Application Publication
(10) Pub. No.: US 2026/0179858 A1
(43) Pub. Date: Jun. 25, 2026

(54) ENERGY STORAGE ELEMENT AND MANUFACTURING METHOD THEREOF, AND ENERGY STORAGE DEVICE AND MANUFACTURING METHOD THEREOF

(71) Applicant: Kioxia Corporation, Tokyo (JP)

(72) Inventors: Masamichi YOKOMIZO, Chigasaki Kanagawa (JP); Teruyuki NARITA, Machida Tokyo (JP); Syogo SHIMAMOTO, Yokohama Kanagawa (JP)

(21) Appl. No.: 19/317,018

(22) Filed: Sep. 2, 2025

(30) Foreign Application Priority Data
Dec. 23, 2024 (JP) 2024-225909

(51) Int. Cl. H01G 9/15; H01G 9/00; H01G 9/008; H01G 9/02; H01G 9/035; H01G 9/04; H01G 9/045; H01G 9/055; H01G 9/07

(52) U.S. Cl. CPC H01G 9/151; H01G 9/0029; H01G 9/008; H01G 9/02; H01G 9/035; H01G 9/045; H01G 9/055; H01G 9/07; H01G 2009/05

(57) ABSTRACT

According to one embodiment, an energy storage element includes a stacked body formed by stacking a strip-shaped first electrode member and a strip-shaped second electrode member and having a first region and a second region different from the first region. The stacked body includes a first winding part in which the first region is wound around a first winding axis and a second winding part in which the second region is wound around a second winding axis different from the first winding axis.

### CROSS-REFERENCE TO RELATED APPLICATION(S)

This application is based upon and claims the benefit of priority from Japanese Patent Application No. 2024-225909, filed Dec. 23, 2024, the entire contents of which are incorporated herein by reference.

### FIELD

Embodiments described herein relate generally to an energy storage element and a manufacturing method thereof, and an energy storage device and a manufacturing method thereof.

### BACKGROUND

A wound type energy storage element, which has a structure in which a first electrode and a second electrode are wound with a separator interposed therebetween, is known.

### BRIEF DESCRIPTION OF THE DRAWINGS

FIGS. 1A to 1C are, respectively, a perspective view, a structural diagram and an exploded view of an energy storage element according to a first embodiment.

FIG. 2 is a cross-sectional view of a stacked body according to the first embodiment.

FIGS. 3A and 3B are, respectively, a perspective view and a cross-sectional view of an energy storage device according to the first embodiment.

FIG. 4 is a structural diagram of the energy storage device according to the first embodiment.

FIG. 5 is a block diagram of a memory system incorporating the energy storage device according to the first embodiment.

FIG. 6 is a flowchart illustrating an example of a manufacturing process for the energy storage device according to the first embodiment.

FIGS. 7A to 7C are process diagrams illustrating an example of the manufacturing process for the energy storage device according to the first embodiment.

FIGS. 8A and 8B are additional process diagrams illustrating an example of the manufacturing process for the energy storage device according to the first embodiment.

FIGS. 9A and 9B are cross-sectional views illustrating an example of a winding method for the energy storage device according to the first embodiment.

FIGS. 10A to 10D include a perspective view and a cross-sectional view of an energy storage element according to a comparative example and the energy storage element according to the first embodiment.

FIGS. 11A and 11B are structural diagrams illustrating the mounting structure of the energy storage device according to the comparative example and the energy storage devices according to the first embodiment.

FIG. 12 is a perspective view illustrating the energy storage element according to a modification of the first embodiment.

FIGS. 13A and 13B are perspective views illustrating an energy storage element according to a second embodiment.

### DETAILED DESCRIPTION

Embodiments provide an energy storage element and a manufacturing method thereof, and an energy storage device and a manufacturing method thereof, which enhance flexibility in the design of how the energy storage element can be mounted.

In general, according to one embodiment, an energy storage element includes a stacked body formed by stacking a strip-shaped first electrode member and a strip-shaped second electrode member and having a first region and a second region different from the first region. The stacked body includes a first winding part in which the first region is wound around a first winding axis and a second winding part in which the second region is wound around a second winding axis different from the first winding axis.

Hereinafter, embodiments will be described with reference to the drawings. In the following description, the elements with substantially the same functions and configurations are given the same reference numerals, and repeated description of these elements may be omitted. All descriptions of an embodiment are also applicable as descriptions of another embodiment, unless explicitly or self-evidently excluded. Terms “parallel”, “orthogonal”, or “same” as used herein may encompass “substantially parallel”, “substantially orthogonal”, or “substantially the same”, respectively. When a plurality of members are described herein as “stacked”, this may include cases where the members are stacked in an offset manner in a direction parallel to the stack surface.

In addition, in this description, “anode” and “cathode” may also be alternatively referred to as “positive electrode” and “negative electrode”, respectively.

While certain materials may be used herein as examples, other materials may be applied as long as the effects of the disclosure can be obtained.

In addition, any of the steps in the method flow of the embodiments is not limited to the example order and may be performed in a different order than the example order and/or in parallel with another step, unless indicated otherwise.

### 1. First Embodiment

An energy storage element and an energy storage device according to a first embodiment will be described. An electrolytic capacitor element and an electrolytic capacitor device will be described below as examples of the energy storage element and the energy storage device. In addition, an electrolytic capacitor refers to a capacitor that uses an oxide film as a dielectric, as described below.

### 1.1 Structure of Electrolytic Capacitor Element

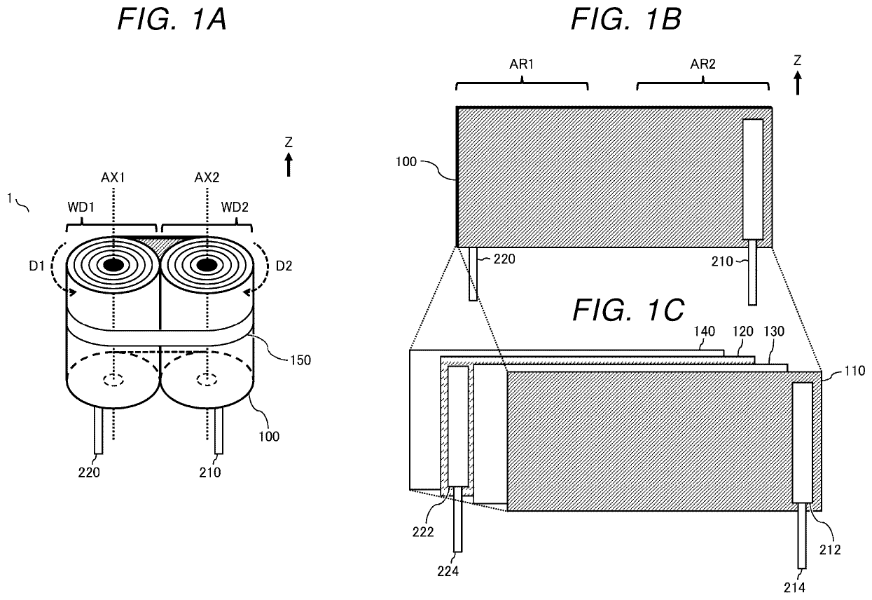

First, the structure of an electrolytic capacitor element 1 of the present embodiment will be described with reference to FIGS. 1A to 1C. FIG. 1A shows a perspective view illustrating an example of the structure of the electrolytic capacitor element 1 according to the present embodiment. FIG. 1B shows a structural diagram illustrating an example of the structure when winding structures of a first winding part WD1 and a second winding part WD2 illustrated in FIG. 1A are unwound, and FIG. 1C shows an exploded view illustrating an example of a stacked structure of a stacked body 100. In FIG. 1A, a plurality of concentric circles of different diameters on an upper surface of the stacked body 100 is illustrated, but this is a simplified drawing. A spiral line is representative of the actual design. The same applies for the upper surface of the stacked body 100 in the other drawings.

As illustrated in FIG. 1A, the electrolytic capacitor element 1 includes the stacked body 100 having the first winding part WD1 and the second winding part WD2, an element fixing tape 150, an anode lead 210, and a cathode lead 220.

The element fixing tape 150 is a member for securing the first winding part WD1 and the second winding part WD2 of the stacked body 100 in the wound state. The element fixing tape 150 is, for example, a film of polypropylene or the like. At least a portion of one side of the element fixing tape 150 is an adhesive surface coated with an adhesive.

Details of the stacked body 100, the anode lead 210 and the cathode lead 220 will be described below.

The first winding part WD1 and the second winding part WD2 are structures in which the stacked body 100 is wound around a first winding axis AX1 and a second winding axis AX2, respectively. In the electrolytic capacitor element 1, the first winding axis AX1 and the second winding axis AX2 are substantially parallel to each other. As illustrated in FIG. 1A, the first winding part WD1 and the second winding part WD2 are wound on the same side of the stacked body 100. In the electrolytic capacitor element 1, the first winding axis AX1 and the second winding axis AX2 may be imaginary axes. For example, if the first winding part WD1 has a cylindrical shape as illustrated in FIG. 1A, the first winding axis AX1 is a line segment or a straight line passing through the center of the circle of the cylindrical shape.

Here, with +Z direction and −Z direction defined, the winding directions of the first winding part WD1 and the second winding part WD2 are compared. The +Z direction and the −Z direction are parallel to a short direction of the stacked body 100. More precisely, the +Z direction and the −Z direction are parallel to the short direction of the stacked body 100 when the winding structure of the stacked body 100 is unwound. The −Z direction is the direction in which the anode lead 210 extends from the stacked body 100. The +Z direction is the direction opposite to the −Z direction. If the +Z direction and the −Z direction are not distinguished, they are simply referred to as “Z direction” (See FIG. 1B).

It is to be noted that the −Z direction defined above is for convenience in the present embodiment. The −Z direction does not necessarily need to be defined based on the physical configuration of the electrolytic capacitor element 1, and either of the two directions, which are simply parallel to the Z direction, may be chosen as the −Z direction and the same discussion as described below is possible.

Hereinafter, in the first winding part WD1, a direction around the first winding axis AX1, in which the stacked body 100 is wound from the outside to the inside, is referred to as a first winding direction D1. Likewise, hereinafter, in the second winding part WD2, a direction around the second winding axis AX2, in which the stacked body 100 is wound from the outside to the inside is referred to as a second winding direction D2. As illustrated in FIG. 1A, the first winding direction D1 and the second winding direction D2 are directions opposite to each other. In this description, when it is described that “two winding directions are in the same direction”, it means that “both winding directions are clockwise” or “both winding directions are counterclockwise” when each winding direction is viewed in the +Z direction. In FIG. 1A, when viewed in the +Z direction, the first winding direction D1 is counterclockwise and the second winding direction D2 is clockwise.

Next, the detailed configuration of the electrolytic capacitor element 1 will be described with reference to FIGS. 1B and 1C. FIG. 1B is a structural diagram illustrating an example of the structure when winding structures of a first winding part WD1 and a second winding part WD2 illustrated in FIG. 1A are unwound, and FIG. 1C is an exploded view illustrating an example of a stacked structure of the stacked body 100. In addition, “AR1” in FIG. 1B indicates a region in the stacked body 100 that corresponds to the first winding part WD1 after winding (hereinafter, referred to as a first region AR1). Likewise, “AR2” indicates a region in the stacked body 100 that corresponds to the second winding part WD2 after winding (hereinafter, referred to as a second region AR2). For example, the first region AR1 includes one end of the stacked body 100 in a longitudinal direction, and the second region AR2 includes the other end of the stacked body 100 in the longitudinal direction.

The electrolytic capacitor element 1 includes an anode member 110, a cathode member 120, separators 130 and 140, an anode lead tab 212, an anode lead wire 214, a cathode lead tab 222, and a cathode lead wire 224. In this case, the anode member 110, the separator 130, the cathode member 120, and the separator 140 are stacked in this order to form the stacked body 100. The anode lead tab 212 and the anode lead wire 214 form the anode lead 210, and the cathode lead tab 222 and the cathode lead wire 224 form the cathode lead 220.

The anode member 110 is a strip-shaped electrode foil formed of a valve metal such as aluminum, tantalum, titanium, and niobium, or alloys thereof. Like the anode member 110, the cathode member 120 is a strip-shaped electrode foil formed of a valve metal or alloys thereof. In addition, the anode member 110 and the cathode member 120 may be formed of the same material or of different materials.

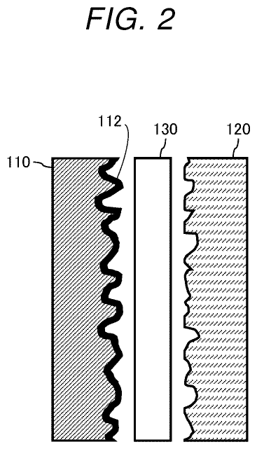

Hereinafter, structures of the surfaces of the anode member 110 and the cathode member 120 will be described with reference to FIG. 2. FIG. 2 shows a cross-sectional view illustrating the cross-sectional structure of the stacked body 100. It is to be noted that the separator 140 is omitted in FIG. 2. As illustrated in FIG. 2, the surfaces of the anode member 110 and the cathode member 120 are subjected to an etching process to form unevenness. For example, the etching process is a process aimed at increasing the surface area of the electrodes. An oxide film 112 is formed on a surface of the anode member 110. The oxide film 112 serves as a dielectric in the electrolytic capacitor element 1. It is to be noted that the etching process described above is not required. In addition, an oxide film or carbon layer or the like may be formed on a surface of the cathode member 120.

Returning to FIGS. 1A to 1C, the structure of the electrolytic capacitor element 1 will be further described.

For example, the separators 130 and 140 are strip-shaped electrolytic paper or non-woven fabric. For example, the separators 130 and 140 are formed of cellulose. For example, the separators 130 and 140 serve to retain an electrolytic solution as described below. Alternatively, the separators 130 and 140 serve to prevent a short circuit caused by a contact between the anode member 110 and the cathode member 120.

The anode lead tab 212 and the anode lead wire 214 are conductive members electrically connected to the anode member 110. For example, the anode lead wire 214 is connected to the anode member 110 via the anode lead tab 212. The cathode lead tab 222 and the cathode lead wire 224 are conductive members electrically connected to the cathode member 120. For example, the cathode lead wire 224 is connected to the cathode member 120 via the cathode lead tab 222. It is to be noted that the anode lead 210 and the cathode lead 220 do not necessarily need to be provided separately as a lead tab and a lead wire, and instead may be configured as a single integral member. In addition, at least one of the lead tab and the lead wire may be rod-shaped, wire-shaped, or strip-shaped.

As illustrated in FIG. 1B, the anode lead 210 is connected to the anode member 110 in the second region AR2 of the stacked body 100. In addition, the cathode lead 220 is connected to the cathode member 120 in the first region AR1 of the stacked body 100. However, this is not required. That is, for example, both the anode lead 210 and the cathode lead 220 may be connected to the anode member 110 and the cathode member 120, respectively, in the first region AR1 of the stacked body 100.

The stacked body 100 is immersed in the electrolytic solution during a manufacturing process of the electrolytic capacitor element 1. The electrolytic solution is a solution or dispersion solution that includes an electrolyte. The electrolyte is, for example, an amine salt of a carboxylic acid or a conductive polymer. In addition, the electrolytic solution includes, for example, polyol compounds, lactone compounds, or sulfone compounds as solvents or dispersants. The electrolytic solution can be obtained through a combination of various electrolytes and solvents or dispersants.

By immersing the stacked body 100 in the electrolytic solution, the electrolytic solution or electrolyte permeates the separator 130 or 140 and is retained between the anode member 110 and the cathode member 120 (not illustrated). In the electrolytic capacitor element 1, the electrolytic solution serves as an extension of the cathode member 120.

### 1.2. Structure of Electrolytic Capacitor Device

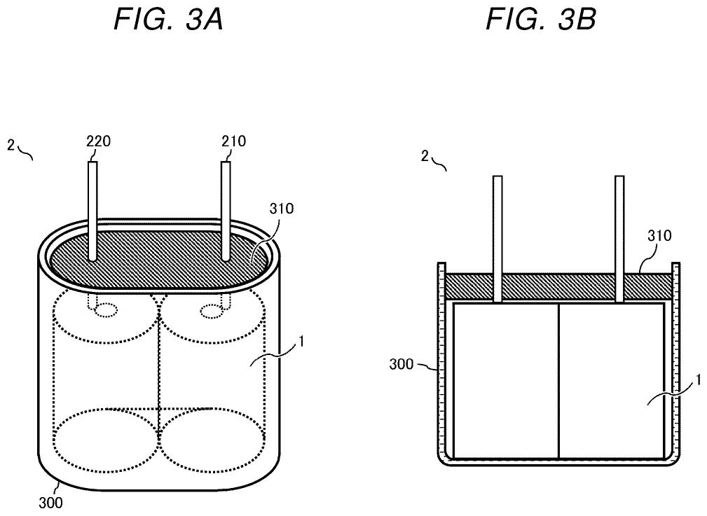

The structure of an electrolytic capacitor device 2 according to the present embodiment will now be described with reference to FIGS. 3A and 3B. FIG. 3A is a perspective view illustrating the structure of the electrolytic capacitor device 2. In addition, FIG. 3B is a cross-sectional view of the electrolytic capacitor device 2.

As illustrated in FIGS. 3A and 3B, the electrolytic capacitor device 2 includes the electrolytic capacitor element 1, a housing 300, and a sealing body 310.

The housing 300 is, for example, formed of aluminum material and is an tubular body with a bottom. The housing 300 is, for example, a stadium-shaped prism. The housing 300 may be covered, for example, by an insulating sleeve (not illustrated).

The sealing body 310 seals an opening of the housing 300 in which the electrolytic capacitor element 1 is housed. The sealing body 310 is formed, for example, by rubber or synthetic resin and has insulating properties. The sealing body 310 has, for example, a stadium-shaped prism.

In the electrolytic capacitor device 2, the electrolytic capacitor element 1 is housed in the housing 300.

The anode lead 210 and the cathode lead 220 of the electrolytic capacitor element 1 are exposed to the outside from the housing 300 through a through via hole formed in the sealing body 310. However, it is not essential for the anode lead 210 and the cathode lead 220 to be exposed to the outside from the housing 300. For example, if a terminal is provided through the housing 300 or the sealing body 310, the leads may be electrically connected to the terminal.

### 1.3 Mounting Structure

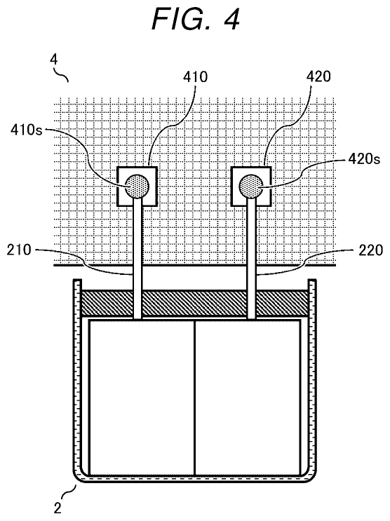

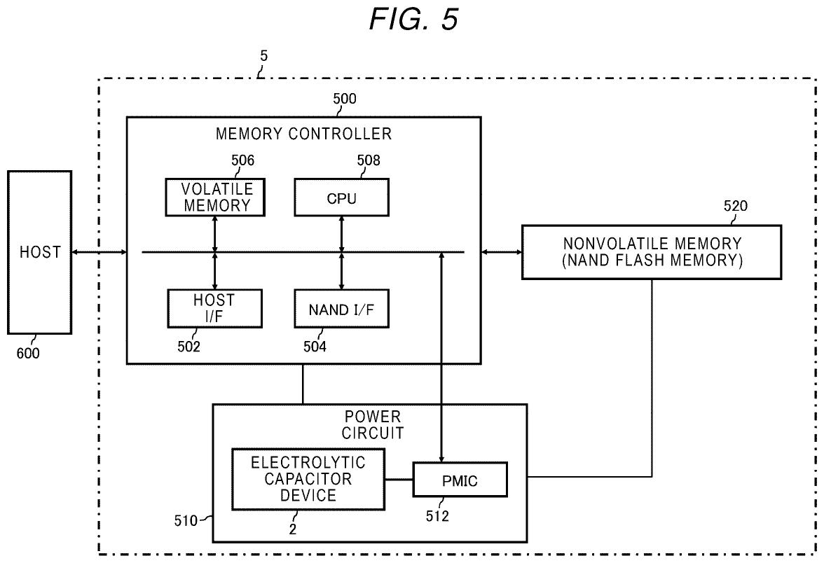

Next, an example of a mounting structure of the electrolytic capacitor device 2 will be described with reference to FIGS. 4 and 5. FIG. 4 is a structural diagram illustrating the mounting structure of the electrolytic capacitor device 2 on a substrate 4.

The substrate 4 is a board on which various electronic components are disposed and connected. In FIG. 4, a portion of the substrate 4 is illustrated. The substrate 4 is provided, for example, in a memory system. The substrate 4 includes pads 410 and 420.

The pads 410 and 420 are conductive parts provided on a surface of the substrate 4. The pads 410 and 420 are electrically connected to, for example, a PMIC 512 (to be described below) disposed on the substrate via wiring provided on or within the surface of the substrate 4.

As illustrated in FIG. 4, in the mounting structure of the electrolytic capacitor device 2, the anode lead 210 is electrically connected to the pad 410 and the cathode lead 220 is electrically connected to the pad 420. In this case, solders 410s and 420s are used to secure the leads 210 and 220, for example.

As described above, in the mounting structure of the electrolytic capacitor device 2, the electrolytic capacitor device 2 is electrically connected to at least two pads on the substrate 4.

It is to be noted that instead of the pads 410 and 420, for example, lands may be used as a structure for the electrolytic capacitor device 2 to be connected to the substrate 4.

For example, the electrolytic capacitor element 1, the electrolytic capacitor device 2 or the substrate 4 is provided in the memory system.

FIG. 5 is a block diagram illustrating a configuration of a memory system 5 including the electrolytic capacitor device 2. As illustrated in FIG. 5, the memory system 5 includes a memory controller 500, a power circuit 510, and a nonvolatile memory 520. The memory system 5 may include a plurality of semiconductor chips. It is to be noted that in the following description, the memory system 5 with NAND flash memory as the nonvolatile memory 520 will be described as an example. Examples of the memory system 5 include a Solid State Drive (SSD).

The memory controller 500 is connected to the NAND flash memory 520 by a NAND bus and to a host 600 by a host bus. The memory controller 500 controls the NAND flash memory 520. In addition, the memory controller 500 writes data to the NAND flash memory 520 and reads data from the NAND flash memory 520 in response to requests received from the host 600. Further, the memory controller 500 controls the power circuit 510 according to requests from the host 600 and various information from the power circuit 510.

For example, the memory controller 500 is a System-on-a-Chip (SoC). The memory controller 500 may include a plurality of semiconductor chips. The memory controller 500 includes a host interface circuit (host I/F) 502, a NAND interface circuit (NAND I/F) 504, a volatile memory 506, and a Central Processing Unit (CPU) 508.

The host interface circuit 502 is connected to the host 600 via a host bus. The host interface circuit 502 transfers data or requests between the host 600 and the CPU 508 or the volatile memory 506.

The NAND interface circuit 504 is connected to the NAND flash memory 520 via a NAND bus and communicates with the NAND flash memory 520. The NAND interface circuit 504 outputs signals to the NAND flash memory 520 based on commands received from the CPU 508.

For example, the volatile memory 506 is Dynamic Random Access Memory (DRAM) or Static Random Access Memory (SRAM). The volatile memory 506 temporarily stores, for example, firmware, various tables, write data from the host 600, and read data from the NAND flash memory 520. If the power supply to the memory system 5 is cut off before the write data transferred from the host 600 and stored in the volatile memory 506 is completely written to the NAND flash memory 520, the write data may be lost.

It is to be noted that the volatile memory 506 may be provided outside the memory controller 500.

The CPU 508 controls the overall operation of the memory controller 500.

The power circuit 510 applies voltage to the memory controller 500 and the NAND flash memory 520. The power circuit 510 includes the PMIC (Power Management Integrated Circuit) 512 and the electrolytic capacitor device 2 described in the present embodiment.

The PMIC 512 controls the application of voltage by the power circuit 510 to the memory controller 500 and the NAND flash memory 520.

During power being supplied by an external device (e.g., the host 600), the power circuit 510 uses the power from the external device to apply voltage to the memory controller 500 and the NAND flash memory 520. In addition, the power circuit 510 charges the electrolytic capacitor device 2 using the power supplied from the external device. On the other hand, in response to the power supply from the external device being cut off, the power circuit 510 applies voltage to the memory controller 500 and the NAND flash memory 520 using the power stored in the electrolytic capacitor device 2.

In response to the power supply from the external device being cut off, the memory controller 500 writes the write data stored in the volatile memory 506 to the NAND flash memory 520, for example, by using the voltage applied using the power stored in the electrolytic capacitor device 2.

The memory system 5 includes, for example, a plurality of semiconductor chips and the electrolytic capacitor device 2 mounted on or within the substrate 4. Further, the memory system 5 includes, for example, a housing (not illustrated) in which the substrate is housed.

### 1.4 Manufacturing Process of Electrolytic Capacitor Device

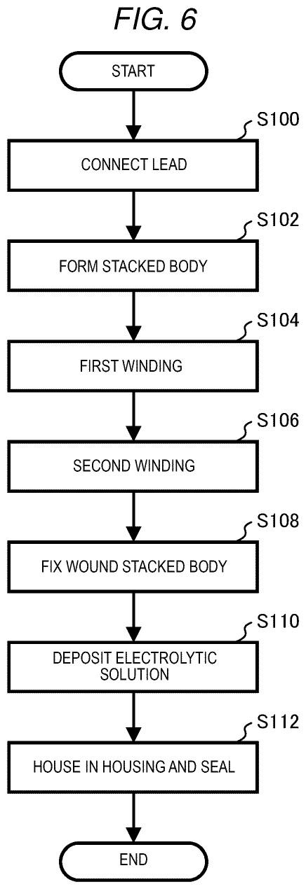

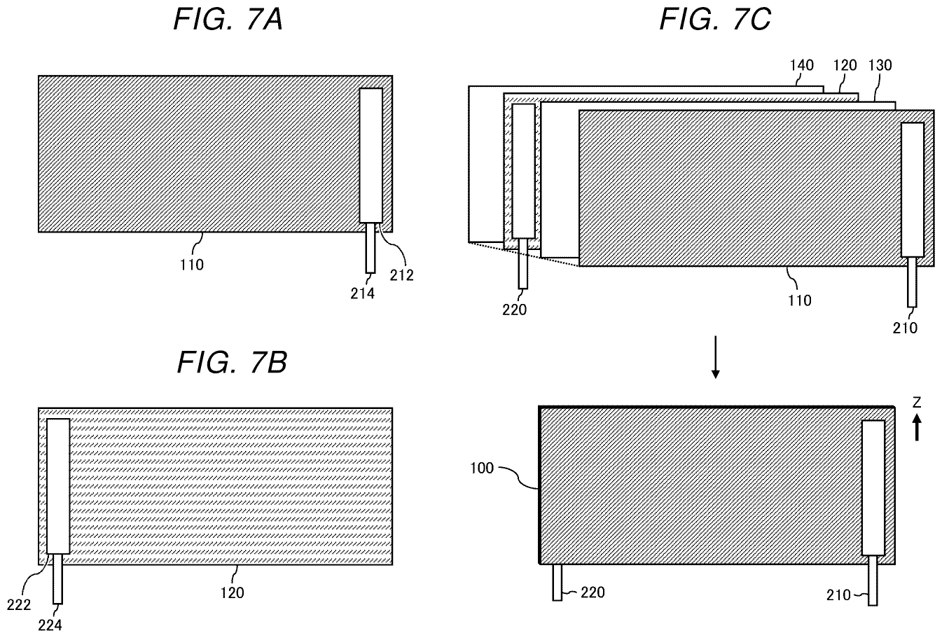

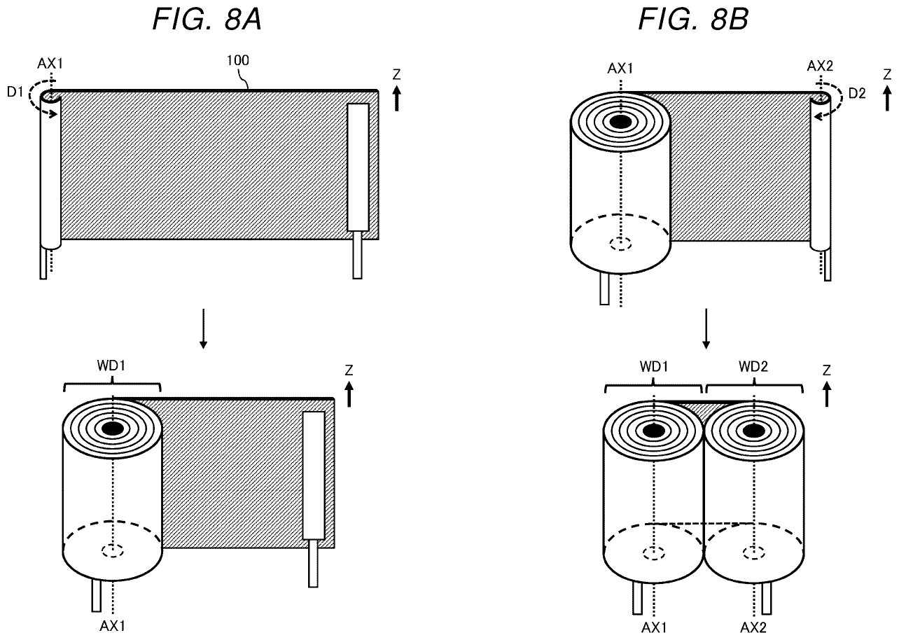

Next, a manufacturing process of the electrolytic capacitor device 2 will be described with reference to FIGS. 6 to 8B. In addition, it is assumed that various processes, including etching process and oxide film formation process for the anode member 110 or the cathode member 120, are performed in parallel with, or before the manufacturing process described below. FIG. 6 is a flowchart illustrating an example of the manufacturing process of the electrolytic capacitor element 1 and the electrolytic capacitor device 2. It is to be noted that steps S100 to S110 correspond to the manufacturing process of the electrolytic capacitor element 1. FIGS. 7A to 8B show process diagrams illustrating each step of the manufacturing process. It is to be noted that in FIGS. 7A to 8B, some reference numerals or symbols may be omitted. In addition, in the following description, the +Z direction and the −Z direction shall be defined in the same way as described with reference to FIG. 1B.

In step S100, the anode lead 210 is connected to the anode member 110 and the cathode lead 220 is connected to the cathode member 120 (FIGS. 7A and 7B). Specifically, for example, the anode lead tab 212 is connected to the anode member 110 and the cathode lead tab 222 is connected to the cathode member 120. In this case, as illustrated in FIG. 7A, the anode lead tab 212 is connected so that its longitudinal axis is parallel to the short direction of the anode member 110, for example. Likewise, the cathode lead tab 222 is connected so that its longitudinal axis is parallel to the short direction of the cathode member 120, for example, as illustrated in FIG. 7B.

In step S102, the anode member 110, the separator 130, the cathode member 120, and the separator 140 are stacked in this order to form the stacked body 100 (FIG. 7C). Here, the anode member 110 and the cathode member 120, after having only one side thereof etched in the etching process, are stacked so that the respective etched surfaces of the anode member 110 and the cathode member 120 face each other through the separator 130. In addition, as illustrated in FIG. 7C, in step S102, the anode member 110 and the cathode member 120 are stacked so that the anode lead 210 and the cathode lead 220 are positioned to be at different ends of the stacked body 100 in the longitudinal direction, respectively. In FIG. 7C, the anode lead 210 is positioned close to a right end of the stacked body 100 in the drawing, and the cathode lead 220 is positioned close to the left end of the stacked body 100 in the drawing.

In step S104, a portion of the stacked body 100 is wound to form the first winding part WD1 (FIG. 8A). The winding process in step S104 is hereinafter referred to as the first winding process. The portion of the stacked body 100 to be wound in step S104 corresponds to the first region AR1 described with reference to FIG. 1B and includes a portion of each of the anode member 110, the cathode member 120, the separator 130, and the separator 140. As illustrated in FIG. 8A, in the first winding process, the stacked body 100 is wound around the first winding axis AX1 parallel to the short direction (i.e., Z direction) of the stacked body 100. The direction of winding around the first winding axis AX1 in this case is identical to the first winding direction D1 described with reference to FIG. 1A. Hereinafter, the direction of winding around the first winding axis AX1 in the first winding process may also be referred to as the first winding direction D1. In the first winding process, the stacked body 100 is wound around a rod-shaped member that serves as an axis, for example. In this case, the rod-shaped member serving as the axis may be removed after the first winding process. Alternatively, the stacked body 100 may be wound around a lead or lead tab as the axis in the first winding process. Alternatively, the stacked body 100 may be wound while being held between tweezers or the like.

Likewise, a portion of the stacked body 100 is wound in step S106 to form the second winding part WD2 (FIG. 8B). The winding process in step S106 is hereinafter referred to as the second winding process. The portion of the stacked body 100 to be wound in step S106 corresponds to the second region AR2 described with reference to FIG. 1B and includes a portion of each of the anode member 110, the cathode member 120, the separator 130, and the separator 140. As illustrated in FIG. 8B, in the second winding process, the stacked body 100 is wound around the second winding axis AX2 parallel to the Z direction. The direction of winding around the second winding axis AX2 in this case is identical to the second winding direction D2 described with reference to FIG. 1A. Hereinafter, the direction of winding around the second winding axis AX2 in the second winding process may also be referred to as the second winding direction D2. In the second winding process, the same winding method as that used in the first winding process can be used.

As illustrated in FIGS. 8A and 8B, the first winding direction D1 in the first winding process and the second winding direction D2 in the second winding process are directions opposite to each other. In FIGS. 8A and 8B, when viewed in the +Z direction, the first winding direction D1 is counterclockwise and the second winding direction D2 is clockwise.

After the first winding process and the second winding process, a portion of the region including one end of the anode member 110 in the longitudinal direction is in the first region AR1 of the stacked body 100, and a portion of the region including the other end of the anode member 110 in the longitudinal direction is in the second region AR2 of the stacked body 100. Likewise, for each of the cathode member 120, the separator 130, and the separator 140, a portion of the region including one end in the longitudinal direction is in the first region AR1 of the stacked body 100, and a portion of the region including the other end in the longitudinal direction is in the second region AR2 of the stacked body 100.

In step S108, the stacked body 100 is fixed in its wound state. Specifically, for example, the element fixing tape 150 is wrapped around the stacked body 100 after the first winding process and the second winding process.

In step S110, the stacked body 100 is immersed in the electrolytic solution. Through this process, the electrolytic solution or electrolyte permeates the separator 130 or 140 and is retained between the anode member 110 and the cathode member 120. The manufacturing process of the electrolytic capacitor element 1 is performed as described in steps S100 to S110.

In step S112, the electrolytic capacitor element 1 is housed in the housing 300 and the housing 300 is sealed by the sealing body 310. In this case, the anode lead 210 and the cathode lead 220 extending from the electrolytic capacitor element 1 are inserted into through via holes formed in the sealing body 310. It is to be noted that the electrolytic capacitor element 1 is housed with the first winding part WD1 and the second winding part WD2 uncut. Specifically, when housed in the housing 300, a portion of the anode member 110 in the first region AR1 and a portion in the second region AR2 are in a state of being electrically conductive to each other, and a portion of the cathode member 120 in the first region AR1 and a portion in the second region AR2 are in a state of being electrically conductive to each other.

The above describes the manufacturing process of the electrolytic capacitor device 2.

It is to be noted that in the present embodiment, the first winding part WD1 and the second winding part WD2 are illustrated as having a cylindrical shape, but the present embodiment is not limited thereto. That is, the first winding part WD1 and the second winding part WD2 may be, for example, a stadium-shaped prism, an oval cylinder, or a square cylinder. These shapes may be formed during the winding process of the stacked body 100, or may be formed by a molding process after the winding process. In addition, the shapes of the first winding part WD1 and the second winding part WD2 may be different from each other.

In addition, in the present embodiment, the anode lead 210 and the cathode lead 220 are illustrated as extending from the stacked body 100 in the same direction along the Z direction, but the present embodiment is not limited to the above. That is, for example, the anode lead 210 may extend from the stacked body 100 in the −Z direction and the cathode lead 220 may extend from the stacked body 100 in the +Z direction. In this case, for example, a through via hole is provided in the bottom of the housing 300, and one of the anode lead 210 and the cathode lead 220 is inserted into the through via hole of the housing 300 and the other is inserted into the through via hole of the sealing body.

The stacking order of the anode member 110 and the cathode member 120 in the stacked body 100 may be reversed. Further, a process such as formation of a through via hole may be performed on at least one of the anode member 110 and the cathode member 120.

In addition, the stacked body 100 may further include, for example, a third separator. That is, the stacked body 100 may be configured by stacking the third separator, the anode member 110, the separator 130, the cathode member 120 and the separator 140 in this order.

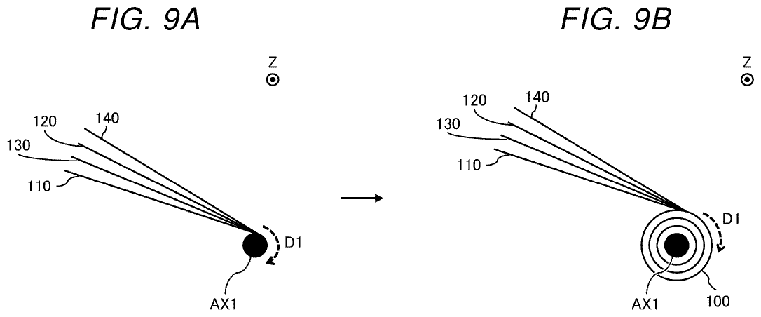

The process of forming the stacked body is performed in step S102 of the manufacturing process, but embodiments are not limited thereto. FIGS. 9A and 9B are cross-sectional views illustrating an example of a winding method in the first winding process. That is, for example, as illustrated in FIGS. 9A and 9B, at least in the first winding process, the anode member 110, the cathode member 120, and the separators 130 and 140 may be supplied to the first winding axis AX1 in an unstacked state, and these members may be wound around the first winding axis AX1, forming a part of the stacked body 100.

### 1.5 Effects

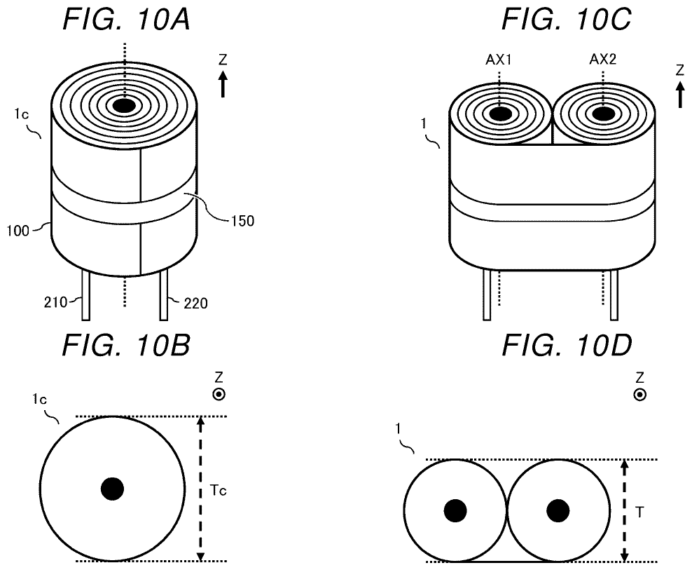

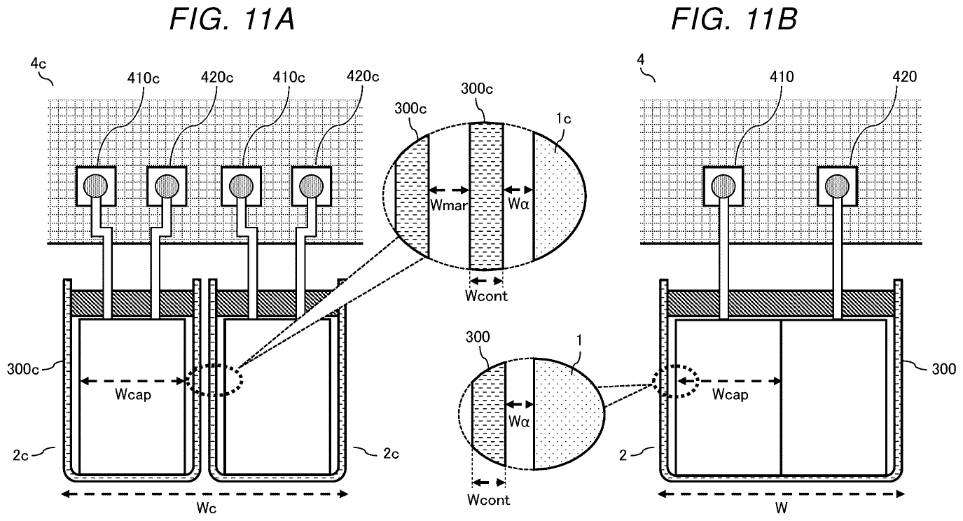

The details of the effects of the energy storage element and the energy storage device according to the present embodiment will be described in comparison with a comparative example with reference to FIGS. 10A to 11B. It is to be noted that the configuration according to the comparative example may be distinguished from the configuration according to the embodiment by adding “c” at the end of the reference numerals. Hereinafter, it is assumed that various members used in an energy storage element 1c according to the comparative example are formed of the same materials as those used for the members in the energy storage element 1 according to the embodiment.

FIG. 10A shows a perspective view of the energy storage element 1c according to the comparative example, and FIG. 10B shows a cross-sectional view of the energy storage element 1c according to the comparative example in a plane perpendicular to the winding axis. In the energy storage element 1c according to the comparative example, the stacked body 100 has a structure wound around a single winding axis.

FIG. 10C shows a perspective view of the energy storage element 1 according to the present embodiment, and FIG. 10D shows a cross-sectional view of the energy storage element 1 according to the present embodiment in a plane perpendicular to the winding axis. The energy storage element 1 according to the present embodiment has a structure in which the stacked body 100, which is same as the stacked body 100 used in the energy storage element 1c according to the comparative example, is wound around two winding axes (the first winding axis AX1 and the second winding axis AX2), respectively. When it is assumed that “the capacitance of the energy storage element 1 according to the present embodiment and the capacitance of the energy storage element 1c according to the comparative example are the same”, a thickness T of the energy storage element 1 according to the present embodiment is calculated to be 1/√2 times a thickness Tc of the energy storage element 1c according to the comparative example. (However, in reality, due to factors such as gaps that may occur at the center of the winding part in the energy storage element 1 according to the present embodiment and the energy storage element 1c according to the comparative example, the thickness T may not be exactly 1/√2 times the thickness Tc but rather approximately 1/√2 times the thickness Tc.) That is, with the energy storage element 1 according to the present embodiment, it is possible to reduce the thickness while maintaining the same capacitance as in the comparative example. When a length of the stacked body 100 according to the present embodiment is made twice longer than in the comparative example, the thickness T of the energy storage element 1 according to the present embodiment will be the same as the thickness Tc of the energy storage element 1c according to the comparative example. That is, in the energy storage element 1 according to the present embodiment, the capacitance may be doubled without increasing its thickness.

Here, it is known that the capacitance Cap of the energy storage element is expressed by Equation (1) below using a surface area Sur of an electrode foil used in the energy storage element and a distance Dist between the electrode foils. It is to be noted that ε in Equation (1) represents the dielectric constant.

$$Cap = ε \times S u r / Dist \qquad ( 1 )$$

In Equation (1), the surface area Sur of the electrode foil is determined by the area of the foil and the unevenness of the foil surface caused by, for example, the etching process. The distance Dist between the electrode foils is determined by the thickness of the separator, for example. Alternatively, for the electrolytic capacitor element described in the present embodiment, the distance Dist between the electrode foils is determined by the thickness of the oxide film formed on the surface of the electrode member.

Thus, since the capacitance Cap of the energy storage element is determined by the configuration of the stacked body 100, the energy storage element 1 and the energy storage element 1c formed using the same stacked body 100 have the same capacitance Cap. That is, the energy storage element 1 according to the present embodiment can achieve the desired capacitance with a smaller thickness of the energy storage element compared to the energy storage element 1c according to the comparative example, thereby enhancing flexibility in the design of how the energy storage element can be mounted. Likewise, the energy storage device 2 (the energy storage element 1+the housing 300) according to the present embodiment can achieve the desired capacitance with a smaller thickness of the energy storage element compared to an energy storage device 2c (the energy storage element 1c+the housing 300c) according to the comparative example, thereby enhancing flexibility in the design of how the energy storage device can be mounted.

FIGS. 11A and 11B are structural diagrams for comparing the configurations of the energy storage device 2 according to the present embodiment and the energy storage device 2c according to the comparative example when each is mounted on a substrate. FIG. 11A shows an example where two energy storage devices 2c according to the comparative example are mounted on a substrate 4c. It is to be noted that the capacitance of the two energy storage elements 1c is assumed to be equal. FIG. 11B illustrates an example in which the energy storage device 2 including the energy storage element 1 having a capacitance equal to the sum of the capacitances of the two energy storage elements 1c illustrated in FIG. 11A is mounted on the substrate 4. The energy storage element 1 illustrated in FIG. 11B is formed using the stacked body 100 with twice the length of a stacked body 100c used for the energy storage element 1c illustrated in FIG. 11A, for example.

In this case, the thickness of the energy storage element 1c illustrated in FIG. 11A and the thickness of the energy storage element 1 illustrated in FIG. 11B are approximately equal to each other. In addition, the width of the energy storage element 1c and the widths of the first winding part and the second winding part of the energy storage element 1 are approximately equal to each other. Hereinafter, the width of the energy storage element 1c may be denoted as Wcap.

Here, a mounting width Wc of the two energy storage devices 2c illustrated in FIG. 11A is compared with a mounting width W of the energy storage device 2 illustrated in FIG. 11B. When a thickness of side walls of the housings 300 and 300c in the energy storage devices 2 and 2c is denoted as Wcont, the mounting width W when the energy storage device 2 is mounted, as illustrated in FIG. 11B, is expressed, for example, by Equation (2) below.

$$W = Wcap \times 2 + Wcont \times 2 + W α \times 2 \qquad ( 2 )$$

It is to be noted that Wα is, for example, a gap between the energy storage element 1 and the housing 300 in the energy storage device 2.

Meanwhile, the mounting width Wc when the two energy storage devices 2c are mounted, as illustrated in FIG. 11A, is expressed, for example, by Equation (3) below.

$$Wc = Wcap \times 2 + W c o n t \times 4 + W α \times 4 + Wmar \qquad ( 3 )$$

It is to be noted that Wmar is, for example, a width of a gap between the energy storage devices 2c in the layout of the energy storage devices 2c. The Wmar is provided, for example, for the purpose of avoiding collisions between the energy storage devices 2c or for the purpose of accommodating dimensional errors in the manufacturing of the housing 300c.

From Equations (2) and (3), the difference between the mounting width W when the energy storage device 2 is mounted and the mounting width Wc when the two energy storage devices 2c are mounted is expressed, for example, by Equation (4) below.

$$Wc - W = Wcont \times 2 + W α \times 2 + Wmar \qquad ( 4 )$$

Thus, the energy storage device 2 (the energy storage element 1+the housing 300) according to the embodiment reduces the mounting width of the energy storage device compared to the case when the two energy storage devices 2c according to the comparative example are mounted to achieve the desired capacitance, thereby enhancing flexibility in the design of how the energy storage device can be mounted.

As illustrated in FIG. 11A, in the substrate 4c on which the two energy storage devices 2c according to the comparative example are mounted, pads 410c and 420c are each provided in pairs to connect the leads. On the other hand, as illustrated in FIG. 11B, in the substrate 4 on which the energy storage device 2 according to the embodiment is mounted, pads 410 and 420 are each provided individually. Thus, the energy storage device 2 according to the embodiment can reduce the number of pads provided on the substrate compared to the case when the two energy storage devices 2c according to the comparative example are mounted to achieve the desired capacitance. Further, the number of wirings to connect the pads to other components on or within the substrate can also be reduced.

In addition, as illustrated in FIG. 1A, in the energy storage element 1 according to the first embodiment, the anode lead 210 and the cathode lead 220 are separated from each other by the first winding part WD1 and the second winding part WD2. This can prevent a short circuit caused by the contact between the anode lead 210 and the cathode lead 220.

As described above, in the energy storage element 1 and the energy storage device 2 (the energy storage element 1+the housing 300) according to the first embodiment, the stacked body includes the first winding part WD1 wound around the first winding axis AX1 and the second winding part WD2 wound around the second winding axis AX2, such that the desired capacitance can be achieved in a space-saving manner compared to the energy storage element 1c and the energy storage device 2c (the energy storage element 1c+the housing 300c) according to the comparative example, thereby enhancing flexibility in the design of how the energy storage element can be mounted. Further, the same effect can also be obtained for the respective manufacturing methods of the energy storage element 1 and the energy storage device 2 according to the present embodiment.

Further, the same effect can also be obtained for the memory system 5 according to the first embodiment. Furthermore, the memory system 5 according to the first embodiment has the effect of reducing the load on the memory controller 500 or the PMIC 512.

In some cases, the size and thickness of the housing in the memory system 5 may be defined by specifications or design. In this case, for example, the energy storage device 2c including the energy storage element 1c according to the comparative example as illustrated in FIG. 11A may not be able to be accommodated in the housing. But using the smaller energy storage device 2c to achieve the desired capacitance to reduce thickness may result in the increased number of energy storage devices 2, making the control of the energy storage devices 2 (e.g., the electrolytic capacitor device 2) by the memory controller 500 or the PMIC 512 complex.

On the other hand, the memory system 5 according to the first embodiment can reduce the number of energy storage devices 2 while reducing thickness, simplify the firmware or processing for controlling the energy storage devices 2, and reduce the load on the memory controller 500 or the PMIC 512.

### 2. Modification of First Embodiment

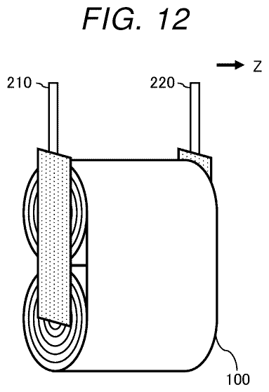

FIG. 12 is a perspective view illustrating a modification regarding the anode lead 210 and the cathode lead 220 in the energy storage element 1 according to the first embodiment. The anode lead 210 and the cathode lead 220 may be connected to end surfaces of the stacked body 100 in the Z direction, as illustrated in FIG. 12. In this case, for example, the anode member 110 and the cathode member 120 are stacked in the stacked body 100 in an offset manner in the Z direction, such that, among the anode member 110 and the cathode member 120, only the anode member 110 is in contact with the anode lead 210 and only the cathode member 120 is in contact with the cathode lead 220.

### 3. Second Embodiment

### 3.1 Configuration of Second Embodiment

Next, a second embodiment will now be described. In the energy storage element 1 according to the second embodiment, the first winding direction D1 of the first winding part WD1 of the stacked body 100 and the second winding direction D2 of the second winding part WD2 are in the same direction. Hereinafter, the differences from the first embodiment will be described.

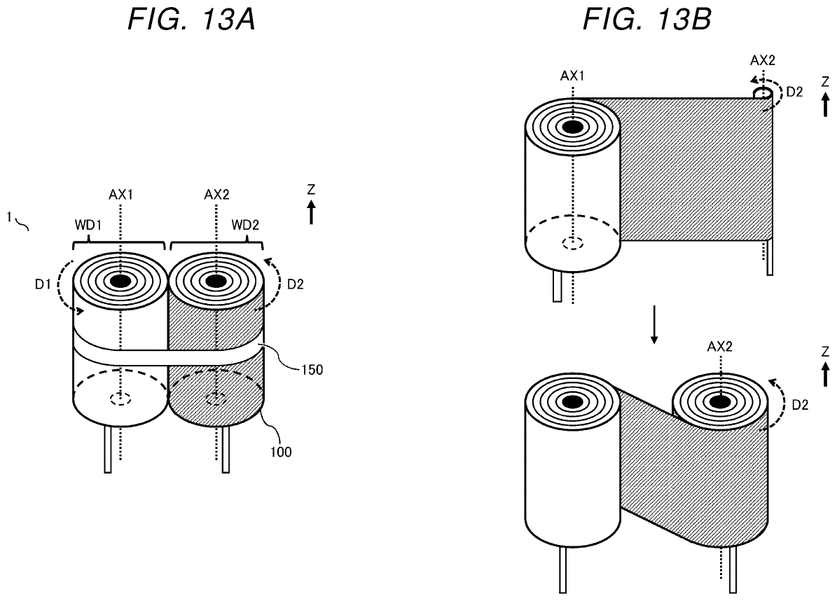

The structure and manufacturing process of the energy storage element 1 according to the second embodiment will be described with reference to FIG. 13. FIG. 13A is a perspective view illustrating an example of the structure of the energy storage element 1 according to the second embodiment. Similar to the energy storage element 1 according to the first embodiment, the stacked body 100 has the first winding part WD1 and the second winding part WD2.

Here, as illustrated in FIG. 13A, the first winding part WD1 and the second winding part WD2 are wound on opposite sides of the stacked body 100. As illustrated in FIG. 13A, the first winding direction D1 of the first winding part WD1 and the second winding direction D2 of the second winding part WD2 are in the same direction. Specifically, in FIG. 13A, both the first winding direction D1 and the second winding direction D2 are counterclockwise when viewed in the +Z direction.

FIG. 13B shows a perspective view illustrating a part of the manufacturing process of the energy storage element 1 according to the second embodiment. Specifically, it is a diagram illustrating an example of the second winding process (step S106 in FIG. 6) described with reference to FIG. 6. As illustrated in FIG. 13B, in the second winding process, the stacked body 100 is wound around the second winding axis AX2 parallel to the Z direction. The second winding direction in this case is identical to the second winding direction D2 described with reference to FIG. 13A. That is, in FIG. 13B, when viewed in the +Z direction, the second winding direction D2 is counterclockwise and is in the same direction as the first winding direction D1.

Other configurations and manufacturing processes are the same as those described with reference to the first embodiment, so their description is omitted.

### 3.2 Effects of Second Embodiment

The energy storage element 1 and the energy storage device 2 in which the energy storage element 1 is housed according to the second embodiment have the same effects as the energy storage element 1 and the energy storage device 2 according to the first embodiment. The same effects can also be obtained for the respective manufacturing methods of the energy storage element 1 and the energy storage device 2 according to the second embodiment.

Further, the energy storage element 1 according to the second embodiment also has the effect of facilitating the manufacturing process of the stacked body 100. In the energy storage element 1 according to the second embodiment, the first winding direction D1 of the first winding part WD1 and the second winding direction D2 of the second winding part WD2 are in the same direction. This makes it less likely for the stacked body 100 to bend during the winding process, allowing the winding process to be performed while easily maintaining the stacked body 100 in the stacked state. When the element fixing tape 150 is wound in the winding fixing process (step S108 in FIG. 6), the element fixing tape 150 is wound in the same direction as the first winding direction D1 and the second winding direction D2, so that the winding fixing process can be performed while easily maintaining the winding state of the first winding part WD1 and the second winding part WD2.

It is to be noted that in this description, the energy storage element 1 and the energy storage device 2 according to the embodiment are described using the electrolytic capacitor with the electrolytic solution as an example, but the embodiment is not limited thereto.

For example, the energy storage element 1 and the energy storage device 2 may be electrolytic capacitors having a solid electrolyte as the electrolyte. The solid electrolyte is, for example, manganese dioxide or a conductive polymer. In this case, for example, the solid electrolyte is stacked instead of the separator 130 in the stacked body 100.

For example, the energy storage element 1 and the energy storage device 2 may be a film capacitor or a ceramic capacitor. The film capacitor is, for example, a capacitor using a polyester film as a dielectric. The ceramic capacitor is a capacitor using ceramic as a dielectric. In this case, for example, the separator 130 is not stacked in the stacked body 100, and the polyester film or ceramic is stacked between the anode member 110 and the cathode member 120. In this case, at least one of the anode member 110 and the cathode member 120 may be formed of a metal or alloy that is not limited to the valve metal. Alternatively, at least one of the anode member 110 and the cathode member 120 may be a vapor-deposited film in which a metal is deposited on a plastic film.

For example, the energy storage element 1 and the energy storage device 2 may be an electric double-layer capacitor. The electric double-layer capacitor is a capacitor using an electric double layer as a dielectric. In this case, for example, activated carbon electrodes are used as the anode member 110 and the cathode member 120.

For example, the energy storage element 1 and the energy storage device 2 may be a primary or secondary battery. The primary battery is, for example, a manganese battery. The secondary battery is, for example, a lithium ion battery.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. An energy storage element comprising a stacked body formed by stacking a strip-shaped first electrode member and a strip-shaped second electrode member and including a first region and a second region different from the first region, wherein
the stacked body includes:
a first winding part in which the first region is wound around a first winding axis; and
a second winding part in which the second region is wound around a second winding axis different from the first winding axis.

2. The energy storage element according to claim 1, wherein the stacked body further includes:
a strip-shaped first separator provided between the first electrode member and the second electrode member; and
a strip-shaped second separator provided on an opposite side of the first electrode member or the second electrode member with respect to the first separator.

3. The energy storage element according to claim 1, wherein a first winding direction in which the first region is wound in the first winding part and a second winding direction in which the second region is wound in the second winding part are directions opposite to each other, and
the first region and the second region are wound on the same side of the stacked body.

4. The energy storage element according to claim 1, wherein a first winding direction in which the first region is wound in the first winding part and a second winding direction in which the second region is wound in the second winding part are the same, and
the first region and the second region are wound on opposite sides of the stacked body.

5. The energy storage element according to claim 1, wherein the first winding axis and the second winding axis are substantially parallel to each other.

6. The energy storage element according to claim 1, wherein the first winding part and the second winding part have a cylindrical shape.

7. The energy storage element according to claim 1, wherein the first electrode member and the second electrode member are aluminum foil or tantalum foil, and
the energy storage element is an electrolytic capacitor.

8. The energy storage element according to claim 7, wherein an oxide film of the aluminum foil or the tantalum foil is used as a dielectric.

9. The energy storage element according to claim 1, wherein the first electrode member and the second electrode member are vapor-deposited films or conductive polymers.

10. The energy storage element according to claim 1, wherein an electrolytic solution is provided between the first electrode member and the second electrode member.

11. The energy storage element according to claim 1, wherein one of the first electrode member and the second electrode member is an anode member, and
the other of the first electrode member and the second electrode member is a cathode member.

12. The energy storage element according to claim 1, further comprising a first lead member connected to the first electrode member and a second lead member connected to the second electrode member.

13. The energy storage element according to claim 12, wherein the first lead member is connected to the first electrode member in the first region, and
the second lead member is connected to the second electrode member in the second region.

14. An energy storage device comprising:
the energy storage element according to claim 1; and
a housing in which the energy storage element is housed.

15. A method for manufacturing an energy storage element including a stacked body which is formed by stacking a strip-shaped first electrode member, a strip-shaped second electrode member, and a strip-shaped first separator provided between the first electrode member and the second electrode member, and which includes a first region and a second region different from the first region, the method comprising:
a first winding process of winding a first part, which is a part of the first electrode member, a second part, which is a part of the second electrode member, and a third part, which is a part of the first separator, around a first winding axis; and
a second winding process of winding a fourth part, which is a part of the first electrode member different from the first part, a fifth part which is a part of the second electrode member different from the second part, and a sixth part which is a part of the first separator different from the third part, around a second winding axis different from the first winding axis.

16. The method for manufacturing an energy storage element according to claim 15, wherein
the first part, the second part, and the third part are in the first region of the stacked body after the first winding process, and
the fourth part, the fifth part, and the sixth part are in the second region of the stacked body after the second winding process.

17. The method for manufacturing an energy storage element according to claim 16, wherein,
in the first winding process, the first electrode member, the second electrode member, and the first separator are wound starting from a first end thereof, and
in the second winding process, the first electrode member, the second electrode member, and the first separator are wound starting from a second end thereof different from the first end.

18. The method for manufacturing an energy storage element according to claim 15, wherein a first winding direction around the first winding axis in the first winding process and a second winding direction around the second winding axis in the second winding process are directions opposite to each other.

19. The method for manufacturing an energy storage element according to claim 15, wherein a first winding direction around the first winding axis in the first winding process and a second winding direction around the second winding axis in the second winding process are the same.

20. A method for manufacturing an energy storage device, comprising:
the method for manufacturing an energy storage element according to claim 15;
a process of connecting a first lead wire to the first part and connecting a second lead wire to the fifth part;
a process of housing the energy storage element, with the fourth part in electrical contact with the first part and the fifth part in electrical contact with the second part, in a housing; and
a process of sealing an opening of the housing with a sealing body.
